(19) United States
(12) Patent Application Publication
(10) Pub. No.: US 2026/0063437 A1
(43) Pub. Date: Mar. 5, 2026

(54) SYSTEMS AND METHODS FOR GENERATING VEHICLE ROUTING DIRECTIONS USING FINITE STATE AUTOMATA

(71) Applicant: Verizon Patent and Licensing Inc., Basking Ridge, NJ (US)

(72) Inventors: Hayden Sean WHITE, Kaiapoi (NZ); Kai LIU, Auckland (NZ); Nathan M. ROBINSON, Christchurch (NZ)

(73) Assignee: Verizon Patent and Licensing Inc., Basking Ridge, NJ (US)

(21) Appl. No.: 18/821,870

(22) Filed: Aug. 30, 2024

(51) Int. Cl. G01C 21/34

(52) U.S. Cl. CPC G01C 21/3492; G01C 21/3446

(57) ABSTRACT

A device may receive current location data and vehicle data associated with a vehicle traveling to a destination, and traffic data identifying traffic and roads in a geographical location associated with the vehicle. The device may generate a route for the vehicle based on the current location data, the vehicle data, and the traffic data, and may perform a common feature analysis of the route to generate link features. The device may process the link features, with a plurality of instruction finite state automata, to generate a list of driving instructions for the vehicle to the destination, and may modify the list of driving instructions to generate a modified list of driving instructions. The device may include additional information with the modified list of driving instructions to generate a final list of driving instructions, and may provide the final list of driving instructions to the vehicle.

### BACKGROUND

The development of accurate turn-by-turn routing directions is a cornerstone of modern navigation systems, essential in providing drivers with clear and timely instructions. Traditional navigation systems, especially those employed in vehicles, rely on a combination of network information and interpretations to deliver a series of directional prompts to a driver.

### BRIEF DESCRIPTION OF THE DRAWINGS

FIGS. 1A-1G are diagrams of an example associated with generating vehicle routing directions using finite state automata.

FIG. 2 is a diagram of an example environment in which systems and/or methods described herein may be implemented.

FIG. 3 is a diagram of example components of one or more devices of FIG. 2.

FIG. 4 is a flowchart of an example process for generating vehicle routing directions using finite state automata.

### DETAILED DESCRIPTION OF EXAMPLE EMBODIMENTS

The following detailed description of example implementations refers to the accompanying drawings. The same reference numbers in different drawings may identify the same or similar elements.

Creation of turn-by-turn routing directions for vehicles has conventionally been managed by a comprehensive logic system that generically processes all forms of driving instructions. However, this shared-logic system for instruction generation can be cumbersome and fragile. For example, changes or updates made to address system functionality or errors in one driving instruction type can inadvertently disrupt correct operation of other driving instruction types. This lack of modularity restricts the ease with which the system can be updated or maintained, posing significant technical challenges in terms of system flexibility, scalability, and robustness.

Moreover, intricacies of road networks often present complex routing scenarios, such as multi-lane highways, roundabouts, tollways, and ramps, that can vary greatly from one geographical area to another. These complexities necessitate a highly adaptive and nuanced approach to instruction generation-one that is capable of discerning and correctly interpreting various road topologies and driver maneuvers. However, the existing approaches with shared logic and centralized processing are not optimized for implementing such fine-grained control, particularly when unique or irregular road configurations are encountered.

Thus, current techniques for generating turn-by-turn routing directions consume computing resources (e.g., processing resources, memory resources, communication resources, and/or the like), networking resources, and/or other resources associated with having updates or changes to one driving instruction type disrupt correct operation of other driving instruction types, failing to discern and correctly interpret various road topologies and driver maneuvers, providing incorrect directions to drivers based on failing interpret various road topologies and driver maneuvers, and/or the like.

Some implementations described herein provide a routing system that generates vehicle routing directions using finite state automata (FSA). For example, the routing system may receive current location data and vehicle data associated with a vehicle traveling to a destination, and traffic data identifying traffic and roads in a geographical location associated with the vehicle. The routing system may generate a route for the vehicle based on the current location data, the vehicle data, and the traffic data, and may perform a common feature analysis of the route to generate link features associated with links of the route. The routing system may process the link features, with a plurality of instruction finite state automata, to generate a list of driving instructions for the vehicle to the destination, and may modify the list of driving instructions to generate a modified list of driving instructions. The routing system may include additional information with the modified list of driving instructions to generate a final list of driving instructions, and may provide the final list of driving instructions to the vehicle.

In this way, the routing system generates vehicle routing directions using finite state automata. For example, the routing system may employ separate FSA for distinct driving maneuvers, which enables precise and isolated generation of directions. This modular approach ensures that the FSA can be updated or replaced independently, resulting in the routing system that facilitates straightforward debugging and enhancement. In addition, the routing system may integrate real-time traffic data into the driving instructions to provide an adaptive mechanism that can modify routes to evade traffic congestion or road incidents, thus conserving fuel, reducing emissions, and optimizing travel times. The routing system may streamline computational efforts required to discern relevant navigational instructions, by reducing a complexity of routing models, and by enabling simpler in-field updates. The utilization of separate FSA for routing tasks may streamline navigation software maintenance and may provide for ongoing refinement. Thus, the routing system may conserve computing resources, networking resources, and/or other resources that would have otherwise been consumed by having updates or changes to one driving instruction type disrupt correct operation of other driving instruction types, failing to discern and correctly interpret various road topologies and driver maneuvers, providing incorrect directions to drivers based on failing interpret various road topologies and driver maneuvers, and/or the like.

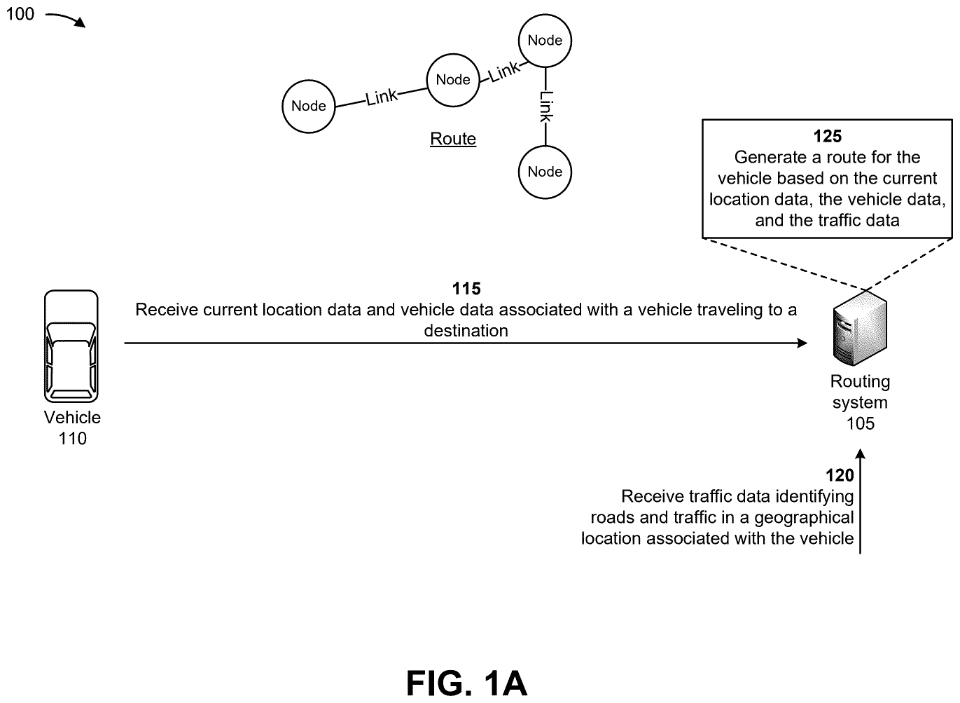

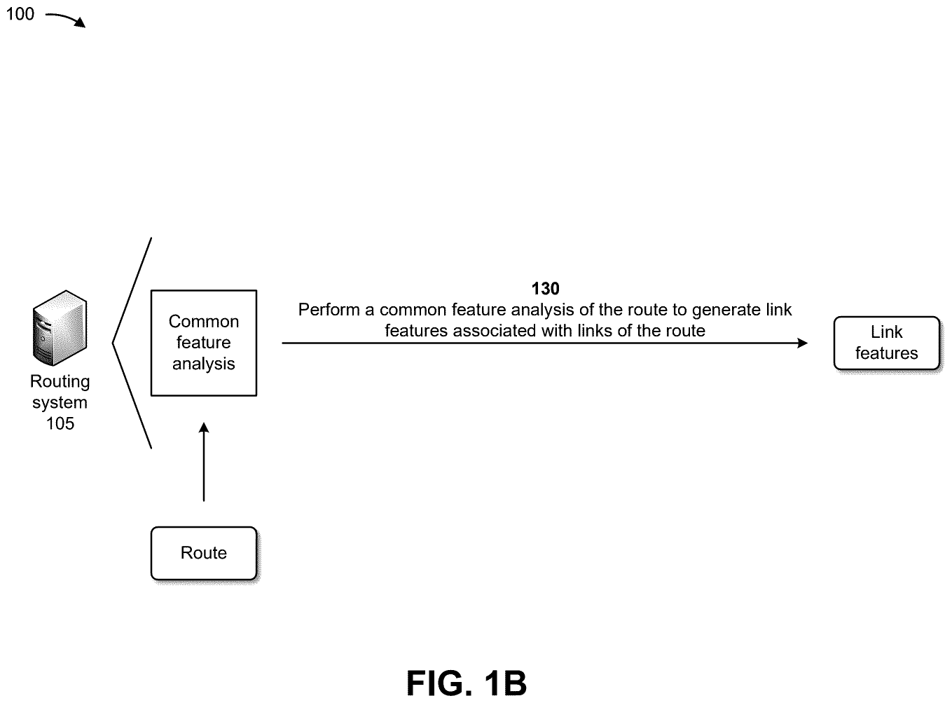

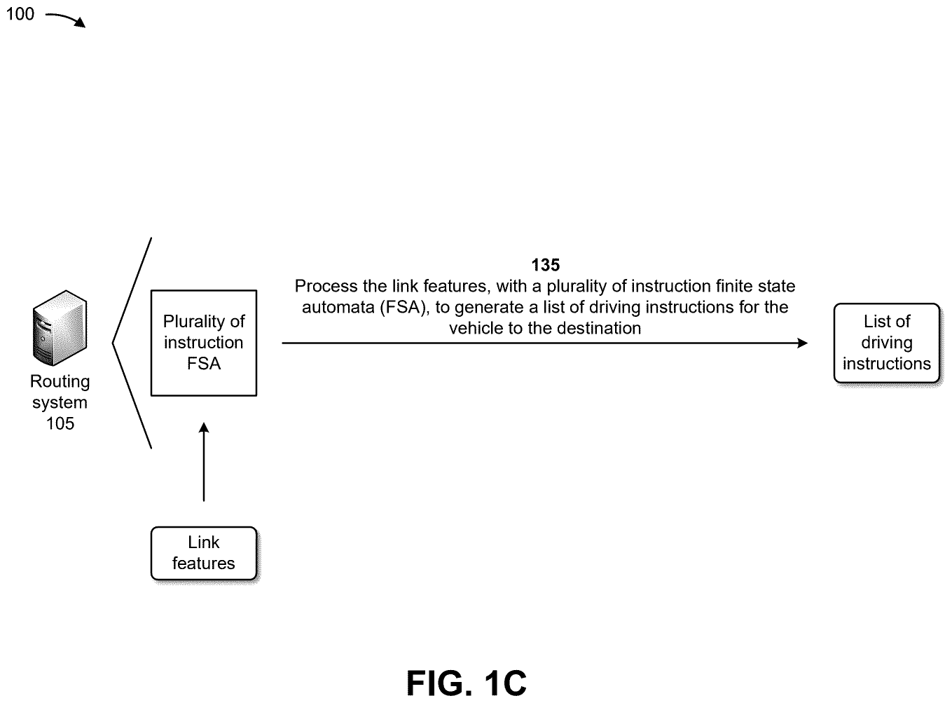

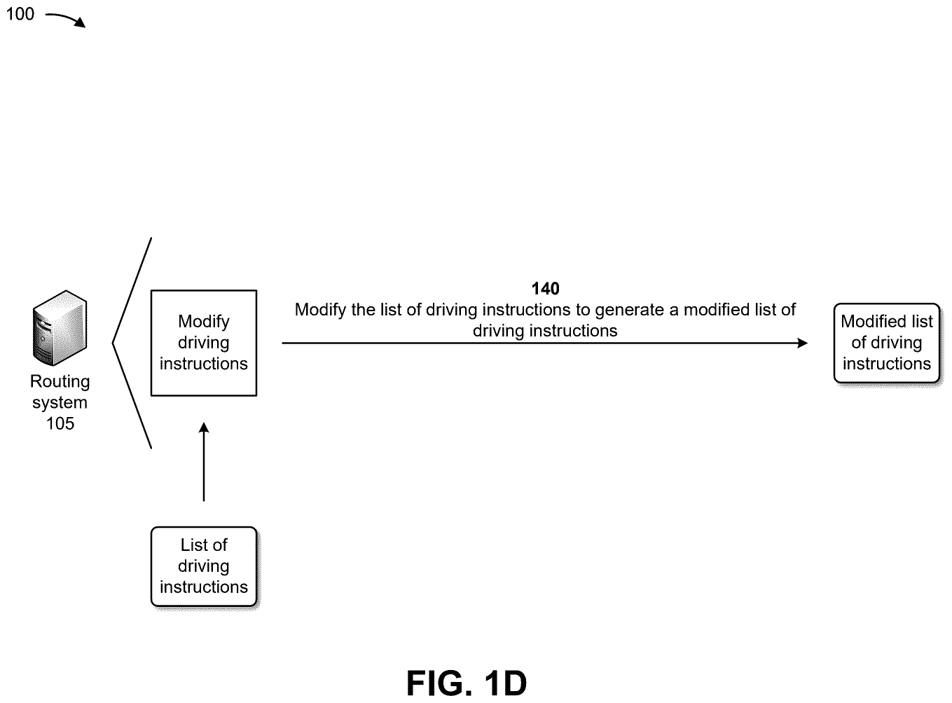

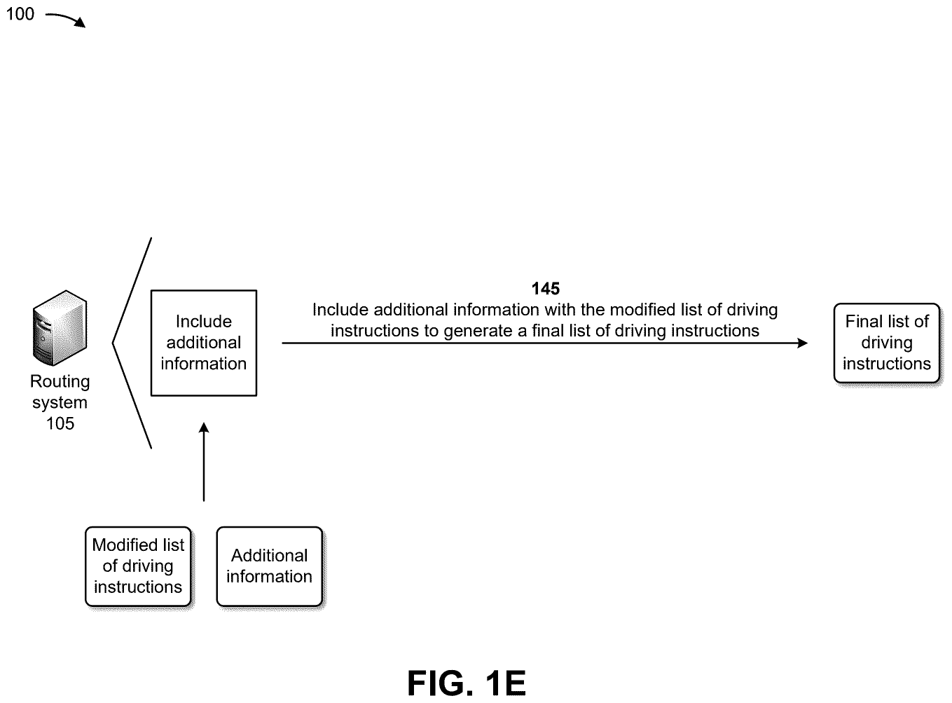

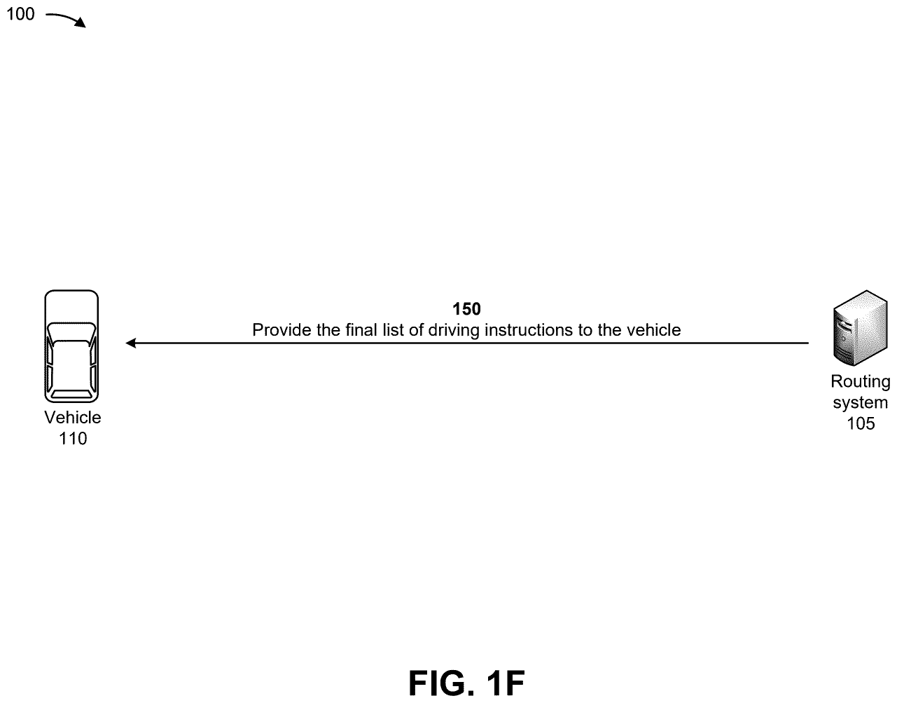

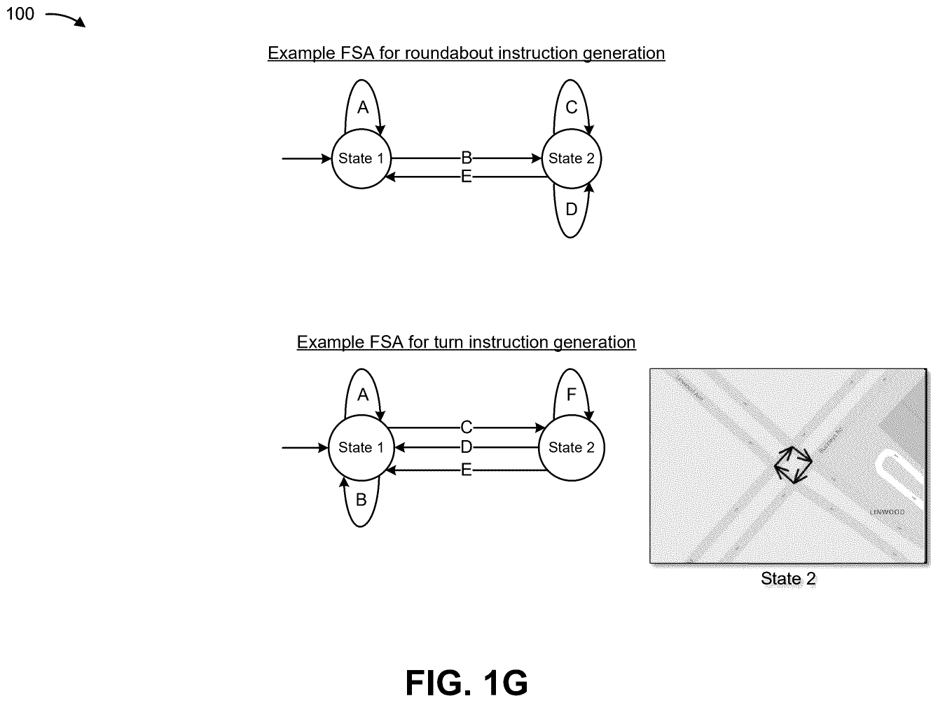

FIGS. 1A-1G are diagrams of an example 100 associated with generating vehicle routing directions using finite state automata. As shown in FIGS. 1A-1G, example 100 includes a routing system 105 associated with a vehicle 110. The routing system 105 may include a system that generates vehicle routing directions using finite state automata. The vehicle 110 may include a car, a truck, a motorcycle, a bus, a boat, farm equipment, construction equipment, among other examples. In some examples, the vehicle 110 may include an autonomous vehicle, a semiautonomous vehicle, or a non-autonomous vehicle. Further details of the routing system 105 and the vehicle 110 are provided elsewhere herein. Although implementations described herein depict a single vehicle 110, in some implementations, the routing system 105 may be associated with multiple vehicles.

As shown in FIG. 1A, and by reference number 115, the routing system 105 may receive current location data and vehicle data associated with the vehicle 110 traveling to a destination. For example, the current location data may include data identifying a current geographical location of the vehicle 110, as generated by a global positioning system (GPS) device of the vehicle 110. The routing system 105 may receive the current location data from the GPS device of the vehicle 110. In some implementations, the current location data may include data derived from alternative positioning systems such as cell tower triangulation, Wi-Fi positioning systems, or other satellite navigation systems. These alternative positioning systems may provide robustness in location tracking by complementing or substituting for GPS in areas with weak satellite signals.

The vehicle data may include data received from a vehicle device, such as a telematics device, a video camera, a dashboard camera, an inertial measurement unit, a three-axis accelerometer, a gyroscope, the GPS device, an on-board diagnostics (OBD) device, a vehicle tracking unit, an electronic control unit (ECU), and/or the like. The vehicle data may include data identifying a speed of the vehicle 110, a direction of the vehicle 110, surroundings of the vehicle 110, and/or the like. Additionally, or alternatively, the vehicle data may include data received from additional sensory systems including proximity sensors, LIDAR, or radar systems of the vehicle 110. These supplemental sensory systems may enhance environmental awareness by providing more detailed information regarding surroundings, obstacles, and adjacent entities of the vehicle 110.

As further shown in FIG. 1A, and by reference number 120, the routing system 105 may receive traffic data identifying traffic and roads in a geographical location associated with the vehicle 110. For example, the routing system 105 may receive the traffic data identifying the traffic and roads in the geographical location of the vehicle 110 from a third party source of such data (e.g., Google Maps, a traffic data source, a map data source, and/or the like). In some implementations, the traffic data received by the routing system 105 may also include historical traffic patterns, predictive traffic modeling, or user-reported traffic incidents and/or slowdowns. This additional traffic data may provide a more comprehensive view of potential travel conditions, allowing for more accurate routing predictions. Additionally, or alternatively, the traffic data may include parking data, if relevant, to assist in making final destination decisions for drivers seeking parking spots. Including parking data can be highly beneficial for urban areas where parking can significantly impact travel time.

As further shown in FIG. 1A, and by reference number 125, the routing system 105 may generate a route for the vehicle 110 based on the current location data, the vehicle data, and the traffic data. For example, the routing system 105 may calculate a route from the current location to the destination location and may generate the initial routing data for the initial route. The initial routing data may include data identifying roads, turns, landmarks, and/or the like that, if followed, will cause the vehicle to travel from the current location to the destination location. The route may include a sequence of links, where each link represents a segment of road. Each link may join a pair of nodes, referred to as a source node and a destination node. Nodes typically represent an intersection in the road, but may also be a point in the road where some properties change (e.g., a divider ending or a road entering a tunnel).

In some implementations, the routing system 105 may incorporate preference settings from the driver or vehicle owner, reflecting preferred types of roads, driving styles, or stopover points, when generating the route. These preferences may enable customization of routes to better align with the individual needs and desires of the user. Additionally, or alternatively, the routing system 105 may provide alternative routes if the route becomes inefficient due to changing traffic conditions and may offer dynamic rerouting options based on user input or vehicle data updates, which enhances flexibility and user control over a journey.

As shown in FIG. 1B, and by reference number 130, the routing system 105 may perform a common feature analysis of the route to generate link features associated with links of the route. For example, the common feature analysis may focus on identifying essential features or properties of each link, such as whether a link represents a straight road, a turn, entry into a roundabout, part of a complex intersection, and/or the like. As each link is analyzed, the link characteristics, derived from the common feature analysis, may be converted into link features which may be utilized for generation of direction instructions. Each link feature may correspond to a segment of the route and may capture important attributes necessary for crafting accurate driving instructions. For example, the routing system 105 may analyze an intersection that has been reached by a current link to determine a quantity of outgoing roads from the intersection, respective turn angles of the outgoing roads, and which outgoing road should be considered a through road.

In some implementations, the routing system 105 may evaluate each link's intersection characteristics to identify traffic signals, stop signs, or yield signs influencing a navigational strategy. This can provide drivers with necessary information to navigate intersections safely, ensuring compliance with traffic laws and reducing the chance of accidents. Additionally, or alternatively, the routing system 105 may utilize the generated link features to determine a necessity of lane-specific instructions for multi-lane roads or highways. This may be useful for complex lane changes or preparing the driver to take a correct exit on a highway, as specifying an exact lane can prevent last-minute lane changes and improve overall traffic flow. Additionally, or alternatively, the link features may include whether the link is a part of a one-way street, a two-way street, whether the link involves a bridge or underpass, or other pertinent roadway characteristics.

In some implementations, the routing system 105 may utilize the common feature analysis to detect special road conditions like construction or closed roads. This may provide for real-time updating of routes to avoid unexpected delays and ensure that the driver is taking the most efficient path to the destination. Additionally, or alternatively, the routing system 105 may incorporate environmental conditions, such as weather or visibility factors, derived from the link features to further customize driving instructions. This proactive approach in routing could enhance safety and reliability of the navigation system.

As shown in FIG. 1C, and by reference number 135, the routing system 105 may process the link features, with a plurality of instruction FSA, to generate a list of driving instructions for the vehicle 110 to the destination. For example, the routing system 105 may include a plurality of independent instruction FSA. The routing system 105 may pass the link features into each of the independent instruction FSA. All of the instruction FSA process a given link before a next link is processed by the plurality of independent instruction FSA. This means that each instruction FSA is able to generate a driving instruction at every stage of the route, if conditions of each instruction FSA are satisfied. Examples of the plurality of independent instruction FSA are described below in connection with FIG. 1G.

The processing of link features by the plurality of instruction FSA allows each FSA to operate independently while focusing on specific driving maneuvers such as turns, roundabouts, ramp directions, and/or the like. For example, separate instruction FSA may handle turn instructions, roundabout navigation, ramp transitions, and various other types of directions independent of one another, which simplifies maintenance and iteration on individual instruction types without the risk of affecting other types.

In some implementations, the list of driving instructions may include instructions directing the vehicle 110 from the current location to the destination location, such as making a turn, entering a highway, exiting a highway, traveling on a road a quantity of miles, and/or the like. In some implementations, the list of driving instructions may include alternative driving maneuvers such as lane changes, intersection-specific instructions, highway exchange details, and/or the like. This may provide a tailored navigation experience that can accommodate unique road configurations and driving preferences. For example, one instruction FSA may specifically handle lane change maneuvers in complex traffic situations or may generate detailed instructions at a complicated highway exchange, aiding the driver in making safe and timely decisions.

Additionally, or alternatively, particular instruction FSA may interchange data with other instructions FSA, where necessary, to accommodate complex routing decisions, such as closely spaced turns or multiple roundabouts. This interconnected approach between instruction FSA may provide a cooperative system capable of handling dynamic and challenging route scenarios with enhanced precision and awareness. Additionally, or alternatively, the instruction FSA may support additional instruction types, such as alerts for upcoming tollways, notifications for road conditions ahead, or suggestions for scenic routes. By incorporating these additional instruction types, the routing system 105 may not only guide the driver but also enrich the driving experience with informative and enjoyable content.

Additionally, or alternatively, the instruction FSA may withhold driving instructions under certain conditions (e.g., to prevent information overload in cases of dense, rapid-succession driving instructions). This selective filtering of driving instructions may ensure that drivers receive only the most pertinent information, which is crucial for maintaining focus and reducing cognitive load during navigation. Additionally, or alternatively, the instruction FSA may customize the driving instructions according to user preferences, such as avoiding left turns or favoring main roads over side streets. Additionally, or alternatively, for scenarios where updates to the routing system 105 are required, the routing system 105 may include a dynamic updating mechanism that allows instruction FSA to be refined or new instruction FSA to be incorporated within the routing system 105.

Additionally, or alternatively, to accommodate future advancements in autonomous driving technologies, the instruction FSA may provide a level of detail suitable for machine interpretation rather than human-friendly prompts. Additionally, or alternatively, as traffic conditions change, the routing system 105 may adjust the list of driving instructions dynamically and in real-time based on updated traffic data.

The routing system 105 may handle complex and variable road network situations by allowing each instruction FSA to add, modify, or omit driving instructions based on the link features being analyzed. As a result, the routing system 105 may generate a list of driving instructions that include critical information, such as distances between maneuvers, turn angles, targeted street names, and/or the like essential for accurate and human-friendly navigation prompts.

As shown in FIG. 1D, and by reference number 140, the routing system 105 may modify the list of driving instructions (e.g., by removing the redundant driving instructions from the list of driving instructions, based on road features, and/or the like) to generate a modified list of driving instructions. For example, the routing system 105 may implement prioritization and conflict resolution techniques when multiple instruction FSA generate driving instructions for the same route segment, ensuring that the most relevant driving instruction is selected or that a composite driving instruction is created. In some implementations, removing the redundant driving instructions may include the routing system 105 consolidating several closely spaced turning instructions into a single multi-turn instruction when the turning instructions occur within a short distance of each other. This consolidation may prevent an overload of driving instructions and may simplify the driver's comprehension by combining multiple maneuvers into an easier to understand format. Additionally, or alternatively, removing the redundant driving instructions may include the routing system 105 replacing a series of detailed driving instructions with simplified landmark-based guidance. This alternative may provide an intuitive approach to navigation, leveraging recognizable landmarks to simplify and reinforce route-following behavior, thus making the driving experience more natural and less reliant on step-by-step instructions.

Additionally, or alternatively, removing the redundant driving instructions may include the routing system 105 weighting the driving instructions based on importance for navigation, and consolidating driving instructions of lower weighted importance. This may ensure that only the most critical information remains, fine-tuning the clarity and effectiveness of the driving instructions provided. In some implementations, the routing system 105 may utilize user preferences to determine which driving instructions to prioritize and which driving instructions to remove, offering a more personalized navigational aid. Personalization may cater to a driver's comfort and driving habits, potentially improving adherence to driving instructions and overall satisfaction with the navigation system. Additionally, the routing system 105 may utilize a heuristic approach to the removal of driving instructions by analyzing historical data about routes most commonly taken by the vehicle 110, thus refining the driving instruction list based on collective driving experience.

By removing the redundant driving instructions, the routing system 105 may provide an improved user experience by presenting a concise set of driving instructions that are easier to follow, potentially leading to safer driving conditions as the driver or a navigation system of the vehicle 110 can more readily process the reduced set of driving instructions, particularly in complex driving scenarios. The reduced quantity of driving instructions may also streamline the cognitive demands on the driver, allowing for better focus on driving.

As shown in FIG. 1E, and by reference number 145, the routing system 105 may include additional information with the modified list of driving instructions to generate a final list of driving instructions. For example, including the additional information with the modified list of driving instructions may include the routing system 105 providing visual cues on a map, such as highlighting the route or animating direction arrows. These visual enhancements can quickly draw the driver's attention to a critical path and upcoming maneuvers, offering a more intuitive navigation experience. Additionally, or alternatively, the inclusion of additional information may include the routing system 105 integrating audio cues into the final list of driving instructions. These auditory signals, like beeps or chimes before an instruction, can alert a driver effectively and prepare the driver for upcoming changes.

Furthermore, the routing system 105 may augment the modified list of driving instructions with graphical symbols or icons representing different types of maneuvers, such as turns or exits, to facilitate comprehension at a glance. The graphical symbols or icons may aid in quicker recognition and response to the driving instructions, especially in complex driving scenarios. Additionally, or alternatively, the routing system 105 may incorporate real-time updates or predictions about upcoming traffic conditions with the modified list of driving instructions. This may ensure that the driver receives the most accurate and timely navigational information.

Additionally, the routing system 105 may provide contextual information (e.g., notable landmarks or buildings) with the modified list of driving instructions to aid in situational awareness and help confirm that the driver is on a correct path. Recognizable landmarks may serve as real-world touchpoints that complement digital instructions. Additionally, or alternatively, the routing system 105 may include safety alerts or recommendations with the modified list of driving instructions. Proactive safety messaging, such as speed limit reminders or cautionary tips based on road conditions, can foster a safer driving environment. Additionally, or alternatively, the routing system 105 may include alternative route suggestions or detours with the modified driving instructions, should the driver choose to deviate from a current suggested path. Additionally, the routing system 105 may include, with the modified list of driving instructions, information that accounts for vehicle-specific considerations, such as weight restrictions or height clearances on particular roads, relevant to the vehicle type being used. Such customization may ensure that a provide route is not only navigable but also permissible for the vehicle 110.

In some implementations, the additional information may include information indicating a distance or a time since a previous driving instruction was transmitted, information indicating a turn angle, information indicating a road name, information indicating whether a route uses a left fork or a right fork in a road, and/or the like. Additionally, the routing system 105 may enhance the modified list of driving instructions by adding context-aware comments, such as cautionary tips or historical notes about certain locations, using the additional information to make the driving instructions more engaging.

As shown in FIG. 1F, and by reference number 150, the routing system 105 may provide the final list of driving instructions to the vehicle 110. For example, the routing system 105 may provide the final list of driving instructions to the vehicle 110 in a variety of formats tailored for effective communication and comprehension by the driver. These formats may include a textual format displayed on a device interface within the vehicle 110, a graphical format that illustrates the driving instructions on a map, an audible format that delivers spoken word instructions through an audio system of the vehicle 110, or a combination of these formats for an enriched directive experience. The chosen format may be based on the vehicle's capabilities, the driver's preferences, and/or the like. The vehicle 110 may receive the final list of driving instructions and may process them to deliver the information to the driver. This may involve displaying the driving instructions on a built-in navigation screen, projecting them onto a heads-up display, or vocalizing them using text-to-speech technology. This multisensory approach ensures that the driver has clear, concise, and timely guidance to reach the desired destination safely and efficiently. Moreover, providing instructions in both visual and audible forms is beneficial for accommodating different user preferences and driving conditions where one modality may be less effective than the other. Additionally, or alternatively, the vehicle 110 may employ an augmented reality (AR) display to overlay the final list of driving instructions on the driver's view of the road, thereby a highly intuitive way to navigate.

Thus, the routing system 105 may provide a streamlined communication system that reduces the likelihood of driver error by ensuring that each driving instruction is clear, actionable, and delivered in a timely manner. Additionally, the flexibility of providing driving instructions in multiple formats allows the driving instructions to be used across a wide range of vehicle models and driver preferences, thus broadening the applicability of the routing system 105.

FIG. 1G depicts examples of finite state automata (e.g., of the routing system 105) for roundabout (e.g., traffic circle) instruction generation and turn instruction generation. The roundabout instruction FSA may include a first state (e.g., a current link is a not roundabout) or a second state (e.g., a current link is a roundabout). There are five possible transitions (e.g., A through E) that can occur as links are fed into the roundabout instruction FSA. A first transition (e.g., A) occurs where currently in state “not roundabout,” the next link is still not a roundabout, and no action is required. A second transition (e.g., B) occurs where currently in state “not roundabout,” the next link is a roundabout, and the action includes moving to state “roundabout.” A third transition (e.g., C) occurs where currently in state “roundabout,” and the next link is still on a roundabout, but the intersection reached at the end of the next link contains a potential exit from the roundabout. In the third transition, the action may include incrementing a counter of how many exits have been encountered. A fourth transition (e.g., D) occurs where currently in state “roundabout,” and the next link is still on a roundabout, but the intersection reached at the end of the next link does not contain a potential exit from the roundabout. No action is required for the fourth transition. A fifth transition (e.g., E) occurs where currently in state “roundabout,” the next link is not a roundabout, and the action may include returning to state “not roundabout” and generating an instruction for using the roundabout. If the fifth transition occurs, an instruction may be generated and the state of the roundabout instruction FSA may reset. This includes resetting the counter of roundabout exits. The generated driving instruction may include a count of exits to facilitate such instructions as “at the roundabout, take the third exit.”

The turn instruction FSA may include a first state (e.g., a current link is a normal road) and a second state (e.g., a current link is an internal component of a complex intersection, as further shown in FIG. 1G). There are six possible transitions (e.g., A through F) between the states that can occur as links are fed into the turn instruction FSA. A first transition (e.g., A) occurs where while on a normal road link, the route continues straight onto another normal road link, and no action is required. A second transition (e.g., B) occurs where while on a normal road link, the route takes an immediate turn onto another normal road link. In the second transition, the action may include generating an instruction for turning from the previous link to the current link. A third transition (e.g., C) occurs where while on a normal road link, the route enters a complex intersection. In the third transition, the action may include moving to state “in complex intersection” and tracking the link from which the intersection was entered. A fourth transition (e.g., D) occurs where while in a complex intersection, the route leaves the complex intersection, continuing straight with respect to the direction from which it entered. In the fourth transition, the action may include moving to state “on normal road.” A fifth transition (e.g., E) occurs where while in a complex intersection, the route leaves the complex intersection at an angle that results in a turn with respect to the direction from which it entered. In the fifth transition, the action may include returning to state “on normal road” and generating an instruction for the turn from the tracked entrance link to the current link. A sixth transition (e.g., F) occurs where while in a complex intersection, the route continues onto another link which is a component of the complex intersection, and no action is required.

Although not shown in FIG. 1G, a ramp instruction FSA may include a first state (e.g., a current link is not a ramp) and a second state (e.g., a current link is a ramp). There are four possible transitions (e.g., A through D) between the states that can occur as links are fed into the ramp instruction FSA. A first transition (e.g., A) may be where while not on a ramp, the route continues onto another link that is not a ramp, and no action is required. A second transition (e.g., B) may be where while not on a ramp, the route enters a ramp. In the second transition, the action may include moving to state “on ramp,” generating an instruction for taking the ramp, and keeping a reference to the generated instruction. A third transition (e.g., C) may be where while on a ramp, the route leaves the ramp. In the third transition, the action may include moving to state “not on ramp,” and updating a target street name for a last instruction based on the name of the current link. A fourth transition (e.g., D) may be where while on a ramp, the route continues on the ramp, and no action is required. In some implementations, the routing system 105 may include other FSA that generate driving instructions in a similar manner as the roundabout instruction FSA, the turn instruction FSA, and the ramp instruction FSA.

In this way, the routing system 105 generates vehicle routing directions using finite state automata. For example, the routing system 105 may employ separate FSA for distinct driving maneuvers, which enables precise and isolated generation of directions. This modular approach ensures that FSA can be updated or replaced independently, resulting in the routing system 105 that facilitates straightforward debugging and enhancement. In addition, the routing system 105 may integrate real-time traffic data into the driving instructions to provide an adaptive mechanism that can modify routes to evade traffic congestion or road incidents, thus conserving fuel, reducing emissions, and optimizing travel times. The routing system 105 may streamline computational efforts required to discern relevant navigational instructions, by reducing a complexity of routing models, and by enabling simpler in-field updates. The utilization of separate FSA for routing tasks may streamline navigation software maintenance and may provide for ongoing refinement. Thus, the routing system 105 may conserve computing resources, networking resources, and/or other resources that would have otherwise been consumed by having updates or changes to one driving instruction type disrupt correct operation of other driving instruction types, failing to discern and correctly interpret various road topologies and driver maneuvers, providing incorrect directions to drivers based on failing interpret various road topologies and driver maneuvers, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

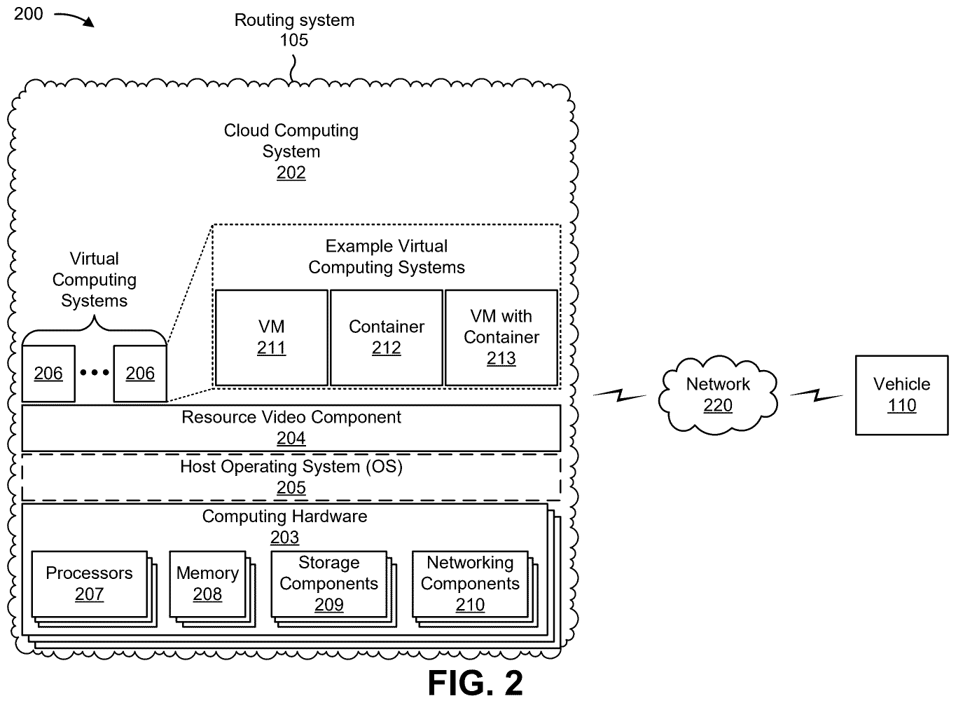

FIG. 2 is a diagram of an example environment 200 in which systems and/or methods described herein may be implemented. As shown in FIG. 2, the environment 200 may include the routing system 105, which may include one or more elements of and/or may execute within a cloud computing system 202. The cloud computing system 202 may include one or more elements 203-213, as described in more detail below. As further shown in FIG. 2, the environment 200 may include the vehicle 110 and a network 220. Devices and/or elements of the environment 200 may interconnect via wired connections and/or wireless connections.

The vehicle 110 may include a car, a truck, a motorcycle, a bus, a boat, farm equipment, construction equipment, and/or the like. In some examples, the vehicle 110 may include an autonomous vehicle, a semiautonomous vehicle, or a non-autonomous vehicle. In some implementations, the vehicle 110 may include a vehicle device capable of receiving, generating, storing, processing, and/or providing information, as described elsewhere herein. The vehicle device may include a communication device and/or a computing device. For example, the vehicle device may include a telematics device, a video camera, a dashboard camera, an inertial measurement unit, a three-axis accelerometer, a gyroscope, a GPS device, an OBD device, a vehicle tracking unit, an ECU, a user device (e.g., a cellular telephone, a laptop computer, and/or the like), and/or the like.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

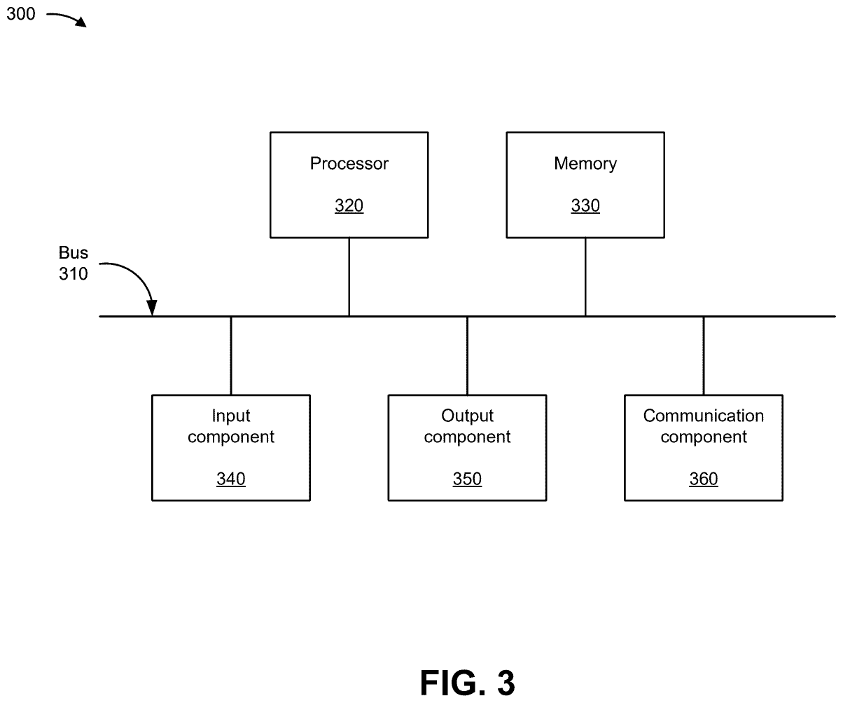

Although the routing system 105 may include one or more elements 203-213 of the cloud computing system 202, may execute within the cloud computing system 202, and/or may be hosted within the cloud computing system 202, in some implementations, the routing system 105 may not be cloud-based (e.g., may be implemented outside of a cloud computing system) or may be partially cloud-based. For example, the routing system 105 may include one or more devices that are not part of the cloud computing system 202, such as a device 300 of FIG. 3, which may include a standalone server or another type of computing device. The routing system 105 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the vehicle and/or the routing system 105. In some implementations, the vehicle and/or the routing system 105 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

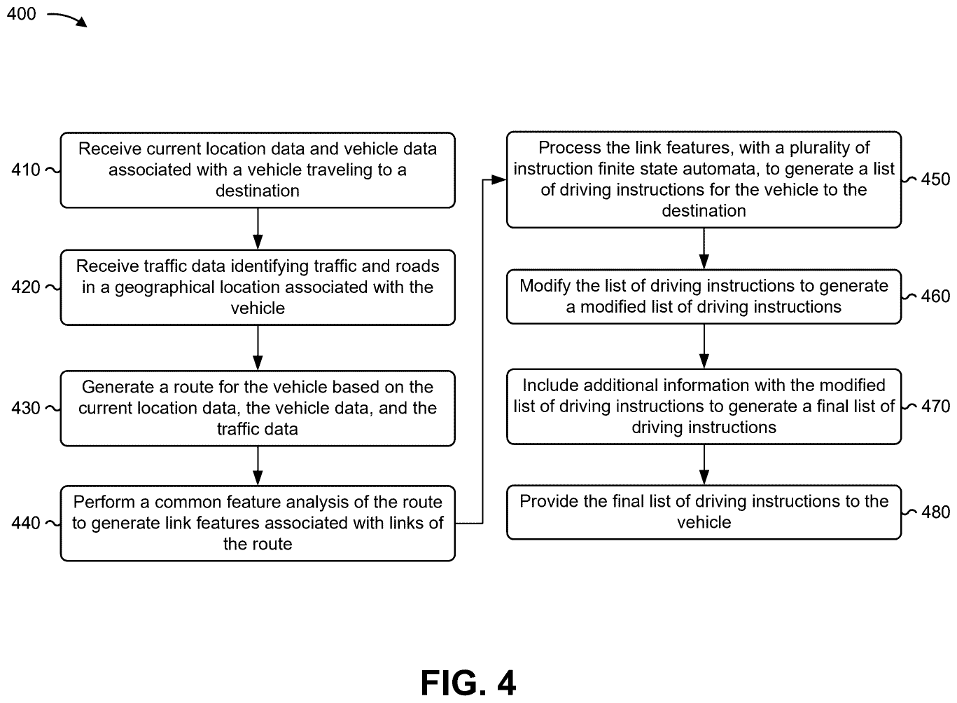

FIG. 4 depicts a flowchart of an example process 400 for generating vehicle routing directions using finite state automata. In some implementations, one or more process blocks of FIG. 4 may be performed by a device (e.g., the routing system 105). In some implementations, one or more process blocks of FIG. 4 may be performed by another device or a group of devices separate from or including the device, such as a vehicle (e.g., the vehicle 110). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving current location data and vehicle data associated with a vehicle traveling to a destination (block 410). For example, the device may receive current location data and vehicle data associated with a vehicle traveling to a destination, as described above.

As further shown in FIG. 4, process 400 may include receiving traffic data identifying traffic and roads in a geographical location associated with the vehicle (block 420). For example, the device may receive traffic data identifying traffic and roads in a geographical location associated with the vehicle, as described above.

As further shown in FIG. 4, process 400 may include generating a route for the vehicle based on the current location data, the vehicle data, and the traffic data (block 430). For example, the device may generate a route for the vehicle based on the current location data, the vehicle data, and the traffic data, as described above.

As further shown in FIG. 4, process 400 may include performing a common feature analysis of the route to generate link features associated with links of the route (block 440). For example, the device may perform a common feature analysis of the route to generate link features associated with links of the route, as described above.

As further shown in FIG. 4, process 400 may include processing the link features, with a plurality of instruction finite state automata, to generate a list of driving instructions for the vehicle to the destination (block 450). For example, the device may process the link features, with a plurality of instruction finite state automata, to generate a list of driving instructions for the vehicle to the destination, as described above. In some implementations, processing the link features, with the plurality of instruction finite state automata, to generate the list of driving instructions includes processing at least one of the link features, with at least one of the plurality of instruction finite state automata, to generate a turn instruction for the vehicle. In some implementations, processing the link features, with the plurality of instruction finite state automata, to generate the list of driving instructions includes processing at least one of the link features, with at least one of the plurality of instruction finite state automata, to generate a U-turn instruction for the vehicle.

In some implementations, processing the link features, with the plurality of instruction finite state automata, to generate the list of driving instructions includes processing at least one of the link features, with at least one of the plurality of instruction finite state automata, to generate a roundabout instruction for the vehicle. In some implementations, processing the link features, with the plurality of instruction finite state automata, to generate the list of driving instructions includes processing at least one of the link features, with at least one of the plurality of instruction finite state automata, to generate a road split instruction for the vehicle. In some implementations, processing the link features, with the plurality of instruction finite state automata, to generate the list of driving instructions includes processing at least one of the link features, with at least one of the plurality of instruction finite state automata, to generate an intersection-specific instruction, a ramp-related instruction, or a lane change instruction for the vehicle.

As further shown in FIG. 4, process 400 may include modifying the list of driving instructions to generate a modified list of driving instructions (block 460). For example, the device may modify the list of driving instructions to generate a modified list of driving instructions, as described above. In some implementations, modifying the list of driving instructions to generate the modified list of driving instructions includes prioritizing the list of driving instructions to identify the redundant driving instructions, and removing the redundant driving instructions from the list of driving instructions based on identifying the redundant driving instructions.

As further shown in FIG. 4, process 400 may include including additional information with the modified list of driving instructions to generate a final list of driving instructions (block 470). For example, the device may include additional information with the modified list of driving instructions to generate a final list of driving instructions, as described above. In some implementations, the additional information includes one or more of information indicating a distance or a time since a previous driving instruction was transmitted, information indicating a turn angle, information indicating a road name, or information indicating whether a route uses a left fork or a right fork in a road. In some implementations, including the additional information with the modified list of driving instructions to generate the final list of driving instructions includes including details of complex intersections or highway exchanges with the modified list of driving instructions to generate the final list of driving instructions.

As further shown in FIG. 4, process 400 may include providing the final list of driving instructions to the vehicle (block 480). For example, the device may provide the final list of driving instructions to the vehicle, as described above. In some implementations, providing the final list of driving instructions to the vehicle includes providing, to the vehicle, a series of spoken driving instructions corresponding to the final list of driving instructions. In some implementations, providing the final list of driving instructions to the vehicle includes providing, to the vehicle, a map and visual indicators corresponding to the final list of driving instructions.

In some implementations, process 400 includes receiving updated traffic data, and modifying the final list of driving instructions based on the updated traffic data. In some implementations, process 400 includes adding a new instruction finite state automaton to the plurality of instruction finite state automata to generate a new driving instruction and without affecting the plurality of instruction finite state automata.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, current location data and vehicle data associated with a vehicle traveling to a destination;
receiving, by the device, traffic data identifying traffic and roads in a geographical location associated with the vehicle;
generating, by the device, a route for the vehicle based on the current location data, the vehicle data, and the traffic data;
performing, by the device, a common feature analysis of the route to generate link features associated with links of the route;
processing, by the device, the link features, with a plurality of instruction finite state automata, to generate a list of driving instructions for the vehicle to the destination;
modifying, by the device, the list of driving instructions to generate a modified list of driving instructions;
including, by the device, additional information with the modified list of driving instructions to generate a final list of driving instructions; and
providing, by the device, the final list of driving instructions to the vehicle.

2. The method of claim 1, wherein processing the link features, with the plurality of instruction finite state automata, to generate the list of driving instructions comprises:
processing at least one of the link features, with at least one of the plurality of instruction finite state automata, to generate a turn instruction for the vehicle.

3. The method of claim 1, wherein modifying the list of driving instructions to generate the modified list of driving instructions comprises:
prioritizing the list of driving instructions to identify the redundant driving instructions; and
removing the redundant driving instructions from the list of driving instructions based on identifying the redundant driving instructions.

4. The method of claim 1, wherein processing the link features, with the plurality of instruction finite state automata, to generate the list of driving instructions comprises:
processing at least one of the link features, with at least one of the plurality of instruction finite state automata, to generate a U-turn instruction for the vehicle.

5. The method of claim 1, wherein providing the final list of driving instructions to the vehicle comprises:
providing, to the vehicle, a series of spoken driving instructions corresponding to the final list of driving instructions.

6. The method of claim 1, further comprising:
receiving updated traffic data; and
modifying the final list of driving instructions based on the updated traffic data.

7. The method of claim 1, wherein providing the final list of driving instructions to the vehicle comprises:
providing, to the vehicle, a map and visual indicators corresponding to the final list of driving instructions.

8. A device, comprising:
one or more processors configured to:
receive current location data and vehicle data associated with a vehicle traveling to a destination;
receive traffic data identifying traffic and roads in a geographical location associated with the vehicle;
generate a route for the vehicle based on the current location data, the vehicle data, and the traffic data;
perform a common feature analysis of the route to generate link features associated with links of the route;
process the link features, with a plurality of instruction finite state automata, to generate a list of driving instructions for the vehicle to the destination;
prioritize the list of driving instructions to identify redundant driving instructions;
modify the list of driving instructions to generate a modified list of driving instructions;
include additional information with the modified list of driving instructions to generate a final list of driving instructions; and
provide the final list of driving instructions to the vehicle.

9. The device of claim 8, wherein the one or more processors, to process the link features, with the plurality of instruction finite state automata, to generate the list of driving instructions, are configured to:
process at least one of the link features, with at least one of the plurality of instruction finite state automata, to generate a roundabout instruction for the vehicle.

10. The device of claim 8, wherein the one or more processors, to process the link features, with the plurality of instruction finite state automata, to generate the list of driving instructions, are configured to:
process at least one of the link features, with at least one of the plurality of instruction finite state automata, to generate a road split instruction for the vehicle.

11. The device of claim 8, wherein the one or more processors, to include the additional information with the modified list of driving instructions to generate the final list of driving instructions, are configured to:
include details of complex intersections or highway exchanges with the modified list of driving instructions to generate the final list of driving instructions.

12. The device of claim 8, wherein the additional information includes one or more of:
information indicating a distance or a time since a previous driving instruction was transmitted,
information indicating a turn angle,
information indicating a road name, or
information indicating whether a route uses a left fork or a right fork in a road.

13. The device of claim 8, wherein the one or more processors are further configured to:
add a new instruction finite state automaton to the plurality of instruction finite state automata to generate a new driving instruction and without affecting the plurality of instruction finite state automata.

14. The device of claim 8, wherein the one or more processors, to process the link features, with the plurality of instruction finite state automata, to generate the list of driving instructions, are configured to:
process at least one of the link features, with at least one of the plurality of instruction finite state automata, to generate an intersection-specific instruction, a ramp-related instruction, or a lane change instruction for the vehicle.

15. A non-transitory computer-readable medium storing a set of instructions, the set of instructions comprising:
one or more instructions that, when executed by one or more processors of a device, cause the device to:
receive current location data and vehicle data associated with a vehicle traveling to a destination;
receive traffic data identifying traffic and roads in a geographical location associated with the vehicle;
generate a route for the vehicle based on the current location data, the vehicle data, and the traffic data;
perform a common feature analysis of the route to generate link features associated with links of the route;
process the link features, with a plurality of instruction finite state automata, to generate a list of driving instructions for the vehicle to the destination;
modify the list of driving instructions to generate a final list of driving instructions; and
provide, to the vehicle, the final list of driving instructions, a map, and visual indicators corresponding to the final list of driving instructions.

16. The non-transitory computer-readable medium of claim 15, wherein the one or more instructions, that cause the device to provide the final list of driving instructions to the vehicle, cause the device to:
provide, to the vehicle, a series of spoken driving instructions corresponding to the final list of driving instructions.

17. The non-transitory computer-readable medium of claim 15, wherein the one or more instructions, that cause the device to process the link features, with the plurality of instruction finite state automata, to generate the list of driving instructions, cause the device to:
process at least one of the link features, with at least one of the plurality of instruction finite state automata, to generate a turn instruction or a roundabout instruction for the vehicle.

18. The non-transitory computer-readable medium of claim 15, wherein the one or more instructions further cause the device to:
receive updated traffic data; and
modify the final list of driving instructions based on the updated traffic data.

19. The non-transitory computer-readable medium of claim 15, wherein the one or more instructions, that cause the device to process the link features, with the plurality of instruction finite state automata, to generate the list of driving instructions, cause the device to:
process at least one of the link features, with at least one of the plurality of instruction finite state automata, to generate a U-turn instruction or a road split instruction for the vehicle.

20. The non-transitory computer-readable medium of claim 15, wherein the one or more instructions further cause the device to:
add a new instruction finite state automaton to the plurality of instruction finite state automata to generate a new driving instruction and without affecting the plurality of instruction finite state automata.
